(19) United States
(12) Patent Application Publication
(10) Pub. No.: US 2022/0320897 A1
(43) Pub. Date: Oct. 6, 2022

(54) CONTROL DEVICE OF ADJUSTING ELECTRIC POWER REMOTELY AND METHOD OF OPERATING THE SAME

(71) Applicant: Fu-Chieh Chen, Taichung (TW)

(72) Inventor: Fu-Chieh Chen, Taichung (TW)

(21) Appl. No.: 17/686,420

(22) Filed: Mar. 4, 2022

(30) Foreign Application Priority Data
Apr. 1, 2021 (TW) 110112275

(51) Int. Cl. H02J 13/00; G06Q 50/06; G06Q 30/02

(52) U.S. Cl. CPC H02J 13/00026; G06Q 50/06; G06Q 30/0202

(57) ABSTRACT

A control device of adjusting electric power remotely contains: multiple stations, multiple areas, at least one control module, and a content management system (CMS). A respective one station includes at least one load and at least one energy storage apparatus having at least one secondary battery. A respective one area includes the multiple stations. A respective one control module includes a microprocessor, a control unit, and a wireless communication unit. The CMS is configured to record and manage the respective one station and the at least one energy storage device and to command, control and order the respective one control module. The CMS is connected with the power supply unit and the respective one control module in a wirelessly and receives a power dispatching instruction sent from the power supply unit, and the power dispatching instruction has the respective one area, a starting time, and an ending time.

### FIELD OF THE INVENTION

The present invention relates to an adjusting electric power remotely in an area.

### BACKGROUND OF THE INVENTION

Electricity consumption in an area can be divided into peak time and off-peak time, and the operating reserve of the power supply unit (Taiwan Power Company in Taiwan) needs to ensure that the peak time can also meet the supply of electricity demand. However, if the total electricity demand in a certain area at a certain time only slightly exceeds the backup capacity, the solution of the power supply unit is to urgently stop the power supply to the area or a specific electricity user to reduce the electricity load, but The problem that the power supply unit cannot guarantee the stability of the power supply is formed. To eliminate this dilemma, the power supply unit can only build power plants or increase generator sets to increase the backup capacity. However, in order to meet the slightly increased demand for electricity, a large amount of budget is invested, and it is worth pondering whether it is in line with economic benefits. Moreover, the power generation of a power plant or generator set is often much higher than the aforementioned situation of “the total electricity demand only slightly exceeds the reserve capacity”, and there will be a waste of resources that cannot be effectively utilized.

The present invention has arisen to mitigate and/or obviate the afore-described disadvantages.

### SUMMARY OF THE INVENTION

The primary objective of the present invention is to provide a control device which is capable of adjusting electric power remotely based on a demand of an electric power to reduce a spare capacity of the power supply unit.

To obtain above-mentioned objective, a control device of adjusting electric power remotely provided by the present invention contains: multiple stations, multiple areas, at least one control module, and a content management system (CMS).

A respective one station includes at least one load and at least one energy storage apparatus. The at least one energy storage apparatus includes at least one secondary battery, the at least one load and the at least one energy storage apparatus are supplied the electric power by a mains system which is managed by a power supply unit.

A respective one area includes the multiple stations.

The at least one control module is configured to mate with the at least one energy storage apparatus, a respective one of the at least one control module includes a microprocessor, a control unit, and a wireless communication unit. The microprocessor is configured to command, control, order, and manage the control unit and a metering unit. The wireless communication unit is configured to execute wireless communication, and the control unit is configured to control openings and closings of a circuit between the mains system and the load, a circuit between the mains system and the at least one energy storage apparatus, and a circuit between the at least one energy storage apparatus and the load.

The content management system (CMS) is configured to record and manage the respective one station and the at least one energy storage device of the respective one area and to command, control and order the respective one control module to operate. The CMS is connected with the power supply unit and the respective one control module in a wireless communication manner. The CMS receives a power dispatching instruction sent from the power supply unit, and the power dispatching instruction has the respective one area, a starting time, and an ending time. The CMS sends the power dispatching instruction to the respective one control module of the respective one area. The microprocessor of the respective one control module receives the power dispatching instruction and orders the control unit to have the closing of the circuit between the mains system and the load, and the opening of the circuit between the at least one secondary battery of the at least one energy storage apparatus and the load in the starting time so that the load supplies the electric power to the at least one energy storage apparatus. The control module orders the control unit to have a closing of a circuit between the at least one secondary battery and the load in a designated stop time and to start the mains system, such that the mains system supplies the electricity power to the load and the at least one secondary battery.

Thereby, the power dispatching instruction is sent by the power supply unit to order the control unit to have the closing of the circuit between the mains system and the load in the starting time and to have the opening of the circuit between the at least one secondary battery of the at least one energy storage apparatus and the load so that the at least one energy storage apparatus supplies the electric power to the load, thus reducing consumption of the electric power in a peak time and a serape capacity of the power supply unit. On the other hand, the at least one energy storage device is capable of adjusting the electric power based on the demand of the electric power.

### BRIEF DESCRIPTION OF THE DRAWINGS

FIG. 1 is a schematic view showing the assembly of a control device of adjusting electric power remotely according to a preferred embodiment of the present invention.

FIG. 2 is another schematic view showing the assembly of the control device of adjusting electric power remotely according to the preferred embodiment of the present invention.

FIG. 3 is a flow chart of a method of operating the control device of adjusting electric power remotely according to the preferred embodiment of the present invention.

### DETAILED DESCRIPTION OF THE PREFERRED EMBODIMENTS

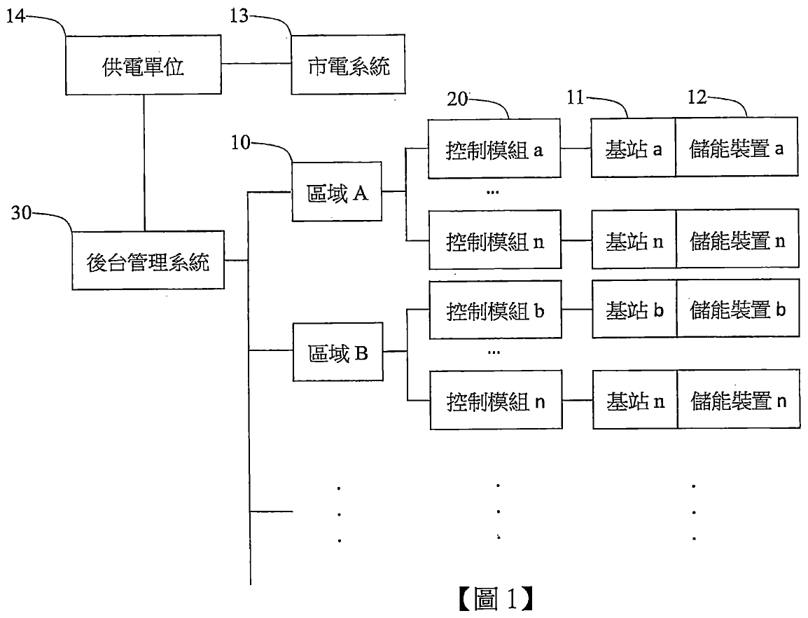

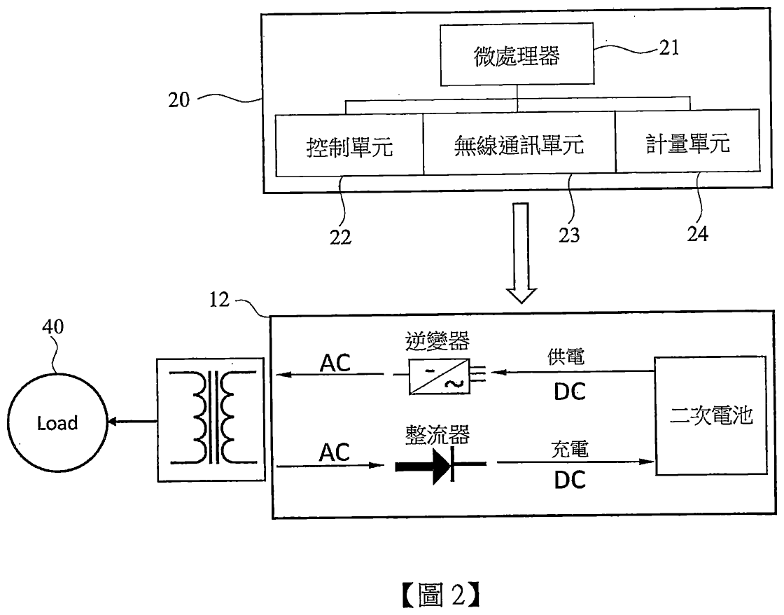

With reference to FIGS. 1 and 2, a control device of adjusting electric power remotely according to a preferred embodiment of the present invention comprises:

multiple stations 11, a respective one station 11 including at least one energy storage apparatus 12, wherein the respective one station 11 includes any one of a cell site, a factory/manufacturing plant, a medical unit, a financial institution, and a building, wherein the at least one energy storage apparatus 12 includes at least one uninterruptible power supply (UPS) configured to supply the electric power to at least one load 40 of the cell site when a mains system 13 operates or does not operate, and the at least one UPS has at least one secondary battery. The respective one station 11 and the at least one energy storage apparatus 12 is well-known art, so further remarks are omitted. Electricity power of the load 40 and the at least one energy storage apparatus 12 are supplied by a power grid 13, and electricity power of the power grid 13 are supplied by a power plant which commands, controls, orders and manages a power generation, wherein the power plant has a power supply unit 14, such as a Taiwan Power Company.

The control device further comprises multiple areas 10, a respective one area includes the multiple station 11.

At least one control module 20 is configured to mate with the at least one energy storage apparatus 12, wherein a respective one of the at least one control module 20 includes a microprocessor 21, a control unit 22, a wireless communication unit 23, and a metering unit 24. Electricity power of the respective one control module 20 is supplied by the mains system 13. The microprocessor 21 is electrically coupled with the control unit 22 and the metering unit 24 and is configured to command, control, order, and manage the control unit 22 and the metering unit 24. The wireless communication unit 23 is configured to execute wireless communication. The control unit 22 is configured to control openings and closings of a circuit between the mains system 13 and the load 40, a circuit between the mains system 13 and the at least one energy storage apparatus 12, and a circuit between the at least one energy storage apparatus 12 and the load 40. The metering unit 24 is configured to calculate a duration (i.e. from a starting time to an ending time) of the closing of the circuit between the mains system 13 and the load 40, wherein the duration of the closing of the circuit between the mains system 13 and the load 40 and an electricity (Wh) of a duration (i.e. from a starting time to an ending time) of supplying electric power of the at least one energy storage apparatus 12 to the load 40 are a parameter by which a subsidy incentive of a power supply is calculated by the power supply unit.

The control device of adjusting the electric power remotely further comprises a content management system (CMS) 30 which is a computer or a mobile device having power conditioning application (App) and configured to record and manage multiple station 11 and the at least one energy storage device 12 of a respective one area 10 and to command, control and order the respective one control module 20 to operate. The CMS 30 is connected with the power supply unit 14 and the respective one control module 20 in a wireless communication manner. The CMS 30 receives a power dispatching instruction sent from the power supply unit 14, wherein the power dispatching instruction has the respective one area 10, a starting time, and an ending time. The CMS 30 sends the power dispatching instruction to the respective one control module 20 of the respective one area 10. The microprocessor 21 of the respective one control module 20 receives the power dispatching instruction and orders the control unit 22 to have the closing of the circuit between the mains system 13 and the load 40, and the opening of the circuit between the at least one secondary battery of the at least one energy storage apparatus 12 and the load 40 in the starting time. Thereafter, the control module 20 orders the control unit 22 to have a closing of a circuit between the at least one secondary battery and the load 40 in a designated stop time and to start the mains system 13, such that the mains system 13 supplies the electricity power to the load 40 and the at least one secondary battery. The metering unit 24 calculates the subsidy incentive of the power supply, and the subsidy incentive of the power supply is saved in the CMS 30 and is sent to the power supply unit 14 to apply a subsidy award.

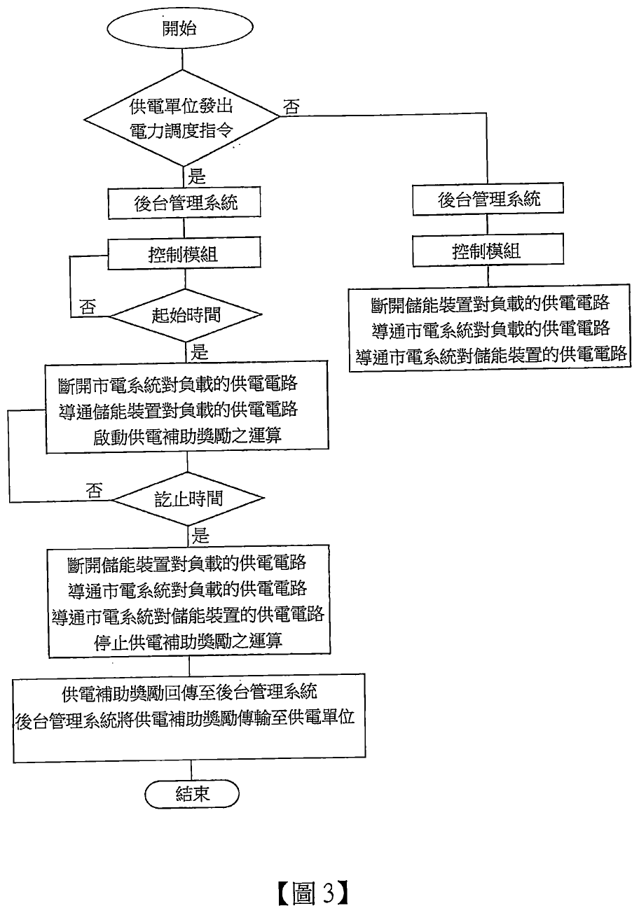

Referring to FIG. 3, a method of operating the control device of adjusting the electric power remotely according to the preferred embodiment of the present invention comprises:

step A) sending the power dispatching instruction to a CMS 30, when acquiring or predicting a total demand of the electric power is more than a spare capacity of the power supply unit 14 in the respective one area 10 in a predetermined time, wherein the power dispatching instruction has the respective one area 10, a starting time, and an ending time of dispatching the electric power;

step B) receiving the power dispatching instruction by using the CMS 30 and sending the power dispatching instruction to the respective control module 20 of the respective one area 10, wherein the microprocessor 21 of the respective control module 20 receives the power dispatching instruction and orders the control unit 22 to have the closing of the circuit between the mains system 13 and the load 40 in the starting time and to have the opening of the circuit between the at least one secondary battery of the at least one energy storage apparatus 12 and the load 40 so that the at least one energy storage apparatus 12 supplies the electric power to the load 40, and the metering unit 24 calculates the subsidy incentive of the power supply from the starting time to the ending time;

step C) ordering the control unit 22 to have the closing of the circuit between the at least one secondary battery of the at least one storage apparatus 12 and the load 40 by way of the microprocessor 21, have the opening of the circuit between the mains system 13 and the load 40, and have the opening of the circuit between the mains system 13 and the at least one secondary battery of the at least one storage apparatus 12, when reaching the ending time, such that the mains system 13 supplies the electric power to the load 40 and the at least one energy storage device 12, wherein the metering unit 24 stops calculating the subsidy incentive of the power supply in the stopping time, and the subsidy incentive of the power supply is sent to the CMS 30 via the microprocessor 21; and

step D) sending the subsidy incentive of the power supply to the power supply unit 14 by using the CMS 30 so as to apply subsidy award.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A control device of adjusting electric power remotely comprising;
multiple stations, a respective one station including at least one load and at least one energy storage apparatus, wherein the at least one energy storage apparatus includes at least one secondary battery, the at least one load and the at least one energy storage apparatus are supplied the electric power by a mains system which is managed by a power supply unit;
multiple areas, a respective one area including the multiple station;
at least one control module configured to mate with the at least one energy storage apparatus, wherein a respective one of the at least one control module includes a microprocessor, a control unit, and a wireless communication unit; the microprocessor is configured to command, control, order, and manage the control unit and a metering unit; the wireless communication unit is configured to execute wireless communication; and the control unit is configured to control openings and closings of a circuit between the mains system and the load, a circuit between the mains system and the at least one energy storage apparatus, and a circuit between the at least one energy storage apparatus and the load;
a content management system (CMS) configured to record and manage the respective one station and the at least one energy storage device of the respective one area and to command, control and order the respective one control module to operate; wherein the CMS is connected with the power supply unit and the respective one control module in a wireless communication manner; the CMS receives a power dispatching instruction sent from the power supply unit, and the power dispatching instruction has the respective one area, a starting time, and an ending time; wherein the CMS sends the power dispatching instruction to the respective one control module of the respective one area; the microprocessor of the respective one control module receives the power dispatching instruction and orders the control unit to have the closing of the circuit between the mains system and the load, and the opening of the circuit between the at least one secondary battery of the at least one energy storage apparatus and the load in the starting time so that the load supplies the electric power to the at least one energy storage apparatus; and the control module orders the control unit to have a closing of a circuit between the at least one secondary battery and the load in a designated stop time and to start the mains system, such that the mains system supplies the electricity power to the load and the at least one secondary battery.

2. The control device as claimed in claim 1 further comprising: a metering unit electrically coupled with the microprocessor and configured to calculate a duration of the closing of the circuit between the mains system and the load, wherein the duration of the closing of the circuit between the mains system and the load and an electricity of a duration of supplying electric power of the at least one energy storage apparatus to the load are a parameter by which a subsidy incentive of a power supply is calculated by the power supply unit; and the subsidy incentive of the power supply is saved in the CMS and is sent to the power supply unit to apply a subsidy award.

3. The control device as claimed in claim 1, wherein the respective one station is a cell site, and the at least one energy storage apparatus includes at least one uninterruptible power supply (UPS) configured to supply the electric power to the cell site.

4. The control device as claimed in claim 1, wherein a content management system (CMS) is a computer or a mobile device having power conditioning application (App).

5. A method of operating the control device of adjusting the electric power remotely comprises:
step A) sending a power dispatching instruction to a content management system (CMS), when acquiring or predicting a total demand of the electric power is more than a spare capacity of a power supply unit in a respective one of multiple areas in a predetermined time, wherein the power dispatching instruction has the respective one area, a starting time, and an ending time of dispatching the electric power;
step B) receiving the power dispatching instruction by using the CMS and sending the power dispatching instruction to a respective one of at least one control modules of the respective one area, wherein a microprocessor of the respective control module receives the power dispatching instruction and orders the control unit to have a closing of a circuit between the mains system and the load in the starting time and to have an opening of a circuit between at least one energy storage apparatus and the load so that the at least one energy storage apparatus supplies the electric power to the load 40 from the starting time to the ending time;
step C) ordering the control unit to have a closing of a circuit between the at least one secondary battery of the at least one storage apparatus and the load by way of the microprocessor, have an opening of a circuit between the mains system and the load, and have an opening of a circuit between the mains system and the at least one storage apparatus, when reaching the ending time, such that the mains system supplies the electric power to the load and the at least one energy storage device.

6. The method as claimed in claim 5, wherein in the step B), the metering unit calculates the subsidy incentive of the power supply from the starting time; and in the step C), the metering unit stops calculating the subsidy incentive of the power supply in the stopping time, and the subsidy incentive of the power supply is sent to the CMS via the microprocessor.

7. The method as claimed in claim 6 further comprising step D) sending the subsidy incentive of the power supply to the power supply unit by using the CMS so as to apply subsidy award.
